(19) United States
(12) Patent Application Publication
(10) Pub. No.: US 2023/0276397 A1
(43) Pub. Date: Aug. 31, 2023

(54) METHOD FOR GENERATING POSITIONING DATA

(71) Applicant: Sony Group Corporation, Tokyo (JP)

(72) Inventors: Johan HILL, Lund (SE); Basuki PRIYANTO, Lund (SE); Anders BERGGREN, Lund (SE)

(21) Appl. No.: 18/016,378

(22) PCT Filed: Jul. 26, 2021
(86) PCT No.: PCT/EP2021/070846

§ 371 Date: Jan. 16, 2023

(30) Foreign Application Priority Data
Jul. 29, 2020 (SE) 2050927-9

(51) Int. Cl. H04W 64/00; H04L 5/00; H04W 24/10

(52) U.S. Cl. CPC H04W 64/00; H04L 5/0051; H04W 24/10

(57) ABSTRACT

A method carried out in a user equipment (1) for generating positioning data for a location server (130) connected through an access network (120), the method comprising: negotiating positioning configuration data with the location server, the positioning configuration data comprising a determined trustworthiness requirement (600, 601) associated with the positioning; and scheduling (603) of a reference signal for positioning in said access network using a positioning technique dependent on Radio Access Technology, RAT; obtaining (604) a positioning request; generating (610), in response to the positioning request, positioning data by using at least one of: said RAT dependent positioning technique, and a RAT independent positioning technique satisfying said trustworthiness requirement.

### TECHNICAL FIELD

This disclosure relates to the field of positioning, and specifically to generation of positioning data for a location server connected to a wireless network, usable for determination of a position estimation of a wireless device.

### BACKGROUND

Positioning is a term frequently used for determining a position. The determined position may be related to a coordinate system, such as defined by e.g. geographical coordinates, or in relation to another position or object.

Various techniques for positioning of mobile devices are available. One well-known technique involves multi-lateration (e.g. trilateration) and/or multi-angulation (e.g. triangulation) based on received signals, emitted or reflected from a known source. One example is satellite positioning, where positioning signals from satellite transmitters are measured. This may be referred to as Global Navigation Satellite System (GNSS), including a constellation of satellites providing signals from space that transmit positioning and timing data to GNSS receivers. A mobile device comprising a receiver for such signals may thus use this data to determine its position or location.

Mobile wireless communication devices, herein referred to by the commonly used term user equipment (UE), may comprise receivers and logic for generation of positioning data according to several different techniques, including GNSS. One example is positioning in a cellular wireless network, e.g. operated as outlined in one or more of the technical specifications of 3GPP, (the 3rd Generation Partnership Project). This may involve the UE receiving signals from a plurality of base stations of the wireless network, and measuring various characteristics of the received signals, such as one or more of signal strength, time of arrival (ToA), phase, etc. An estimate of the position of the UE can then be calculated based on the measurement data. In various positioning systems, a network node which may be referred to as a location server is connected in, or to, the wireless network, which controls the signaling and positioning process, and which may perform the calculations for determination of the position estimation. One example of such a technique is UE-assisted OTDOA (Observed Time Difference of Arrival). The UE performs measurement, such as Reference Signal Time Difference (RSTD) measurement and then reports the results to the Location Server to be used for positioning estimation.

Different types of positioning techniques provide positioning data with different characteristics, such as accuracy, latency, availability etc. A historic example is that GNSS positioning provides a position estimation accuracy which may be within 10 m, whereas network-based techniques in 4G systems typically provided a lower positioning accuracy of e.g. 50 m or worse. On the other hand, the availability of GNSS signals is normally not particularly good in indoor environments. Other techniques, such as utilizing Bluetooth signals, Wi-Fi signals, sensors, can be used to complement positioning estimation technique in indoor environments.

A need therefore exists for a method for controlling positioning to determine a positioning estimation of a UE connected to a wireless network with certain requirements, including positioning accuracy, taking various aspects of different positioning techniques into consideration.

### SUMMARY

The proposed solution is defined by the terms of the independent claims. This involves inter alia a method carried out in a UE for generating positioning data for a location server connected through an access network. The method comprises:

negotiating positioning configuration data with the location server, the positioning configuration data comprising
a determined trustworthiness requirement associated with the positioning; and
scheduling of a reference signal for positioning in said access network using a positioning technique dependent on Radio Access Technology, RAT;

obtaining a positioning request; and

generating, in response to the positioning request, positioning data by using at least one of: said RAT dependent positioning technique, and a RAT independent positioning technique satisfying said trustworthiness requirement.

The method provides the benefit of providing a mechanism for negotiating a trustworthiness requirement which allows a UE to generate positioning data for a location server while at the same time acknowledging and meeting the need for an efficient positioning process, e.g. in terms of energy efficiency or low latency, by taking the availability of RAT independent techniques into consideration.

Various non-limiting examples falling within this general scope are laid out in the dependent claims and in the following description.

### BRIEF DESCRIPTION OF THE DRAWINGS

The proposed solutions will now be described in more detail with reference to the accompanying drawings, in which various examples of realizing the solutions are outlined.

FIG. 1 schematically illustrates a wireless network according to some examples, in which the proposed solutions may be set out.

FIG. 2 schematically illustrates a UE configured to operate in accordance with the examples laid out herein.

FIG. 3 schematically illustrates a location server configured to operate in accordance with the examples laid out herein.

FIG. 4 schematically illustrates various levels of a parameter associated with a positioning system, by way of example.

FIG. 5 schematically illustrates a flowchart of various process steps carried out in a method operated according to various examples of the proposed solution.

FIG. 6 schematically illustrates a flowchart of a method operated according to various examples of the proposed solution.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

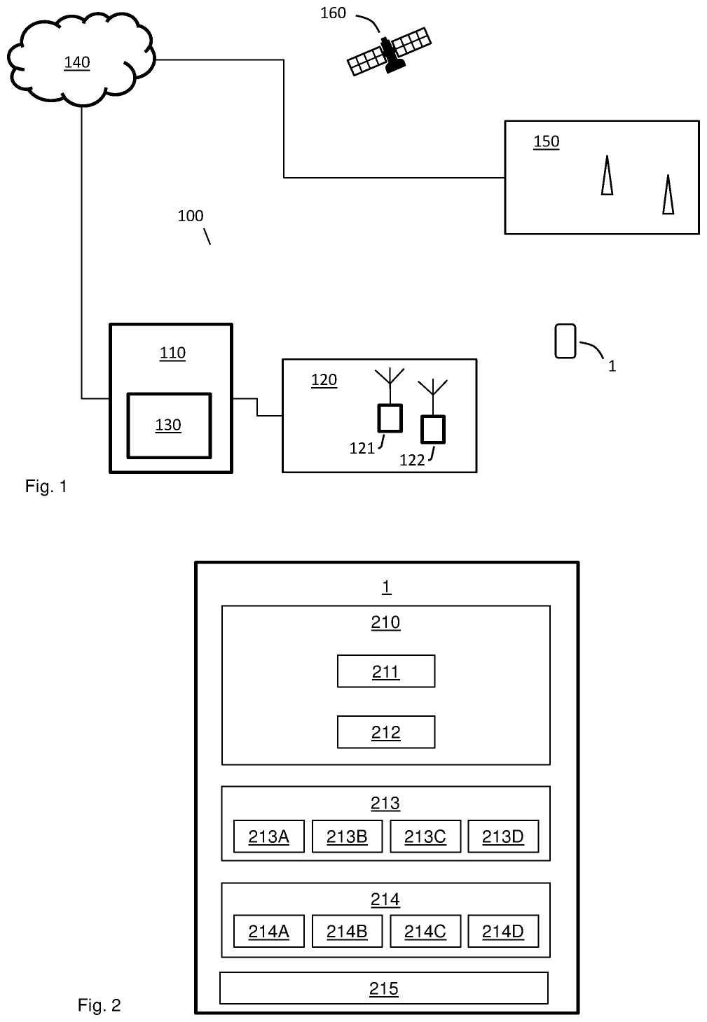

FIG. 1 schematically illustrates a wireless communication scenario, providing an example of a scene in which the solutions provided herein may be incorporated for providing a position estimation of a UE 1.

A wireless network 100 may comprise a core network 110 and one or more access networks 120. The wireless network may be configured according to at least some of the specifications as used by the 3GPP. The core network may e.g. be a 4G EPC or a 5G Core. The core network 110 may further be connected to other communication systems such as the Internet 140. A network node operating as a location server 130 may be connected in the core network 110. In an alternative embodiment, the location server 130 does not form part of the core network 110 but is connected thereto. The access network 120 is connected to the core network 110 and is usable for communication with UEs, such as the illustrated UE 1. The access network 120 may comprise a plurality of access nodes or base stations 121, 122, configured to provide a wireless interface for, inter alia, the UE 1. In a 5G network an access node 121, 122 is typically referred to as a gNB, and this term will occasionally be referred to herein as well. The base stations 121, 122 may be stationary or mobile. The actual point of transmission and reception of each base station may be referred to as a Transmission and Reception Point (TRP), which may coincide with an antenna system of the respective base station.

The UE 1 may be any device operable to wirelessly communicate with the network 100 through the base stations 121, 122, such as a mobile telephone, computer, tablet, a machine to machine (M2M) device, an IoT (Internet of Things) device or other.

FIG. 1 further indicates other systems available to the UE 1 for generating positioning data usable for estimation of the position of the UE 1. In some examples, signals from other wireless transmitters 150 may be detectable in the UE 1, such as Wi-Fi transmitters or Bluetooth transmitters. Moreover, a plurality of satellite transmitters 160 may be provided for GNSS signal transmission.

Before discussing various process solutions for the proposed method, the UE 1 and the positioning server 130 will be functionally discussed on a general level.

FIG. 2 schematically illustrates an example of the UE 1 for use in a wireless network 100 as presented herein, and for carrying out the method steps as outlined. The UE 1 may be a New Radio (NR) UE in which the UE is connected to a 5G NR cellular system 120.

The UE 1 comprises a radio transceiver 213 for communicating with other entities of the radio communication network 100, such as the base stations 121, 122 and other nodes 150, in various frequency bands. The transceiver 213 may thus include a radio receiver and transmitter for communicating through at least an air interface. As an example, the UE1 may comprise one or more of a transceiver 213A for communication with the access network 120, a transceiver 213B for WiFi communication, a transceiver 213C for Bluetooth communication, and a receiver 213D for obtaining GNSS signals.

The UE 1 further comprises logic 210 configured to communicate data, via the radio transceiver, on a radio channel, to the wireless communication network 100 and possibly directly with another terminal by Device-to Device (D2D) communication.

The logic 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic 210 may further include memory storage 212, which may include one or multiple memories and/or one or multiple other types of storage media. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.).

The memory storage 212 is configured for holding computer program code, which may be executed by the processing device 211, wherein the logic 210 is configured to control the UE 1 to carry out any of the method steps as provided herein. Software defined by said computer program code may include an application or a program that provides a function and/or a process. The software may include device firmware, an operating system (OS), or a variety of applications that may execute in the logic 210.

The UE 1 may further comprise an antenna system 214, which may include one or more antenna arrays. In various examples the antenna system 214 comprises different antenna elements configured to communicate with the wireless network 100, and optionally also antenna devices for communication with other nodes 150 and for reception of GNSS signals. As an example, the antenna system 214 may comprise one or more of an antenna 214A for communication with the access network 120, an antenna 214B for WiFi communication, an antenna 214C for Bluetooth communication, and an antenna for receiving GNSS signals.

The UE1 may further comprise one or more sensors usable for positioning of the UE1, such as a gyroscope, a barometer, an accelerometer etc.

Obviously, the UE 1 may include other features and elements than those shown in the drawing or described herein, such as a power supply, a casing, a user interface, further sensors, etc., but are left out for the sake of simplicity.

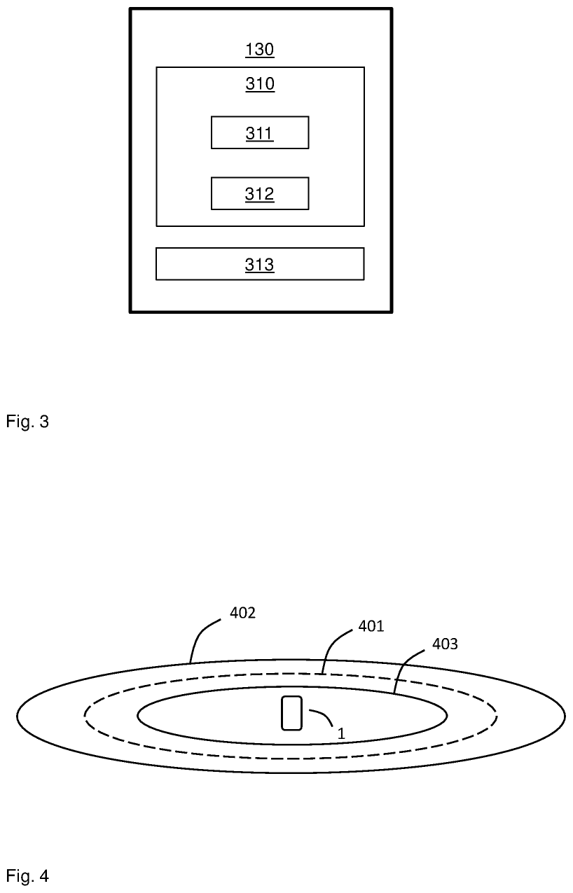

FIG. 3 schematically illustrates an example of the location server (LS) 130 for use in the wireless network 100 as presented herein, and for carrying out the method steps as outlined.

The LS 130 comprises a communication interface 313 for connection to the other nodes of the core network 110.

The LS 130 further comprises logic 310 configured to communicate measurement data and control signals with the access network 120 and with the UE 1, over interface 313, e.g. by using a LTE Positioning Protocol (LPP) as specified in 3GPP TS 37.355 for the communication between LS and UE. The logic 310 may be partly or completely cloud-based or may be installed in a dedicated node device.

The logic 310 may include a processing device 311, including one or multiple processors, microprocessors, data processors, co-processors, and/or some other type of component that interprets and/or executes instructions and/or data. The processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, the memory storage 312 may include a random access memory (RAM), a dynamic random access memory (DRAM), a cache, a read only memory (ROM), a programmable read only memory (PROM), flash memory, and/or some other type of memory. The memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the LS 130 to carry out any of the method steps as provided herein. Software defined by said computer program code may include an application or a program that provides a function and/or a process. The software may include device firmware, an operating system (OS), or a variety of applications that may execute in the logic 310.

As noted, position data such as geo-location coordinates of the UE 1 can be estimated in the location server 130. If needed, the determined position estimation of the UE location can then be communicated back to the UE 1, in RRC (Radio Resource Control) connected mode. However, in 3GPP release 16 “UE based positioning” was introduced, where the UE 1 itself can estimate its position, such as geo-location coordinates. Moreover, further studies have recently been initiated with the objective to address higher accuracy location requirements resulting from new applications and so-called industry verticals.

In the UE 1, many different technologies may be used for localizing a device. As discussed, there are 3GPP based access technologies such as LTE, NR, NB-IoT, LTE-M using different methods based on reference signals in either uplink or downlink, like Cell-Id, enhanced Cell-Id and Reference Signal Time Difference (RSTD) measurements. Common for such technologies is that positioning is based on cooperation with the access network 120. This is known, and referred to herein, as Radio Access Technology (RAT) dependent techniques. Other examples of positioning technologies are various GNSS systems, as noted, such as GPS, GLONASS, Galileo, Beidou and IRNSS acquiring position by satellite signal reception. Moreover, there are positioning technologies based on e.g. Bluetooth, Ultra wideband (UWB), RFID, Wi-Fi, and sensors (e.g. barometer, accelerometer, gyroscope, etc.) that can be used for positioning. On top of this Radar, acoustics, visual pictures and others might be possible as sources for localization. Collectively, these may be referred to as RAT independent techniques, in the sense that the positioning does not as such rely on measurement of signals transmitted between the access network 120 and the UE 1. All those technologies may be used together or stand alone to determine a position estimation, such as geographical coordinates, for the UE 1. The technology with best accuracy may vary a lot and depends, inter alia, on the scenario of the UE 1 and its surroundings. It might be the case that UE 1 has knowledge about its position with good enough accuracy without using positioning methods of 3GPP, i.e. RAT dependent techniques. To schedule any positioning reference signals in the access network 120 in those cases are waste of system resources as well as power consumption.

The 3GPP study item on UE positioning as described in RP-193237 aims at evaluating and specifying enhancements and solutions to meet the following exemplary performance targets associated with positioning:

(a) For general commercial use cases (which may be relevant in the context of 3GPP specification TS 22.261): sub-meter level position accuracy (<1 m).

(b) For IIoT (Industrial IoT) Use Cases (which may be relevant in the context of 3GPP specification 22.804): position accuracy<0.2 m.

The target latency requirement may be <100 ms, and for some IIoT use cases, latency in the order of 10 ms is desired.

One aspect of positioning that may be considered is the trustworthiness of the outcome of a position estimation. A 3GPP study on positioning use cases, TR 22.872, discusses the issue of trustworthiness, using the term integrity, as: “A measure of the trust in the accuracy of the position-related data provided by the positioning system and the ability to provide timely and valid warnings to the UE and/or the user when the positioning system does not fulfil the condition for intended operation.” Examples of trustworthiness, or integrity, parameters can be Accuracy Error, Alert Limit, Target Integrity Risk, Protection Level.

To put the this into perspective, an example of integrity for high accuracy GNSS positioning is provided in 3GPP technical document RP-191919. The primary UE 1 output is the user's estimated position, determined by its GNSS receiver and logic. This estimate will contain some error compared to the true position of the UE 1. To indicate the quality of position determination, the accuracy may also be estimated, e.g. typically given as a 1 sigma (68%) value. This indicates that 68% of position outputs are better than the reported accuracy. Or put differently, 32% of position outputs are worse than the stated accuracy, but without identifying how much worse. For high-assurance positioning, it may be desirable to bound the error to a much higher level of certainty. This is one example of the concept of trustworthiness, or integrity. This may involve defining an Alert Limit (AL) as an upper bound or limit on position error. The Alert Limit is calculated for a Target Integrity Risk (TIR), which gives an allowable rate of occurrence of error greater than the Alert Limit, such as e.g. less than once per 100,000 hours (<10⁻⁵/hour).

Another example of a trustworthiness parameter related to accuracy of positioning may be described with reference to FIG. 4. Location tolerances of different positioning techniques may be different and vary over time and with location. FIG. 4 schematically illustrates the UE 1 and an alert limit 401 associated with a position determination of the UE 1. In this example, the error or accuracy tolerance obtained with a RAT dependent technique is illustrated by the outer limit 402, whereas the corresponding error obtained with a RAT independent technique is represented by the inner limit 403. In other words, the RAT-dependent technique has higher error than the RAT-independent technique, wherein the RAT-independent technique may give better accuracy in the positioning determination.

These examples provide some ways of describing how trustworthiness of positioning is associated with trustworthiness parameters, such as one or more of the exemplified Accuracy Error, Alert Limit, Target Integrity Risk, Protection Level, which set limits as to how trustworthy a position determination can be. Other examples of trustworthiness parameters are conceivable within the concept of the solutions provided herein.

According to a first general aspect of the proposed solution, a method is provided which is carried out in the UE 1 for generating positioning data for the location server 130 connected through the access network 120. The method comprises:

negotiating positioning configuration data with the location server, the positioning configuration data comprising
a determined trustworthiness requirement associated with the positioning; and
scheduling of a reference signal for positioning in said access network using a positioning technique dependent on Radio Access Technology, RAT;

obtaining a positioning request; and

generating, in response to the positioning request, positioning data by using at least one of: said RAT dependent positioning technique, and a RAT independent positioning technique satisfying said trustworthiness requirement.

According to a second general aspect of the proposed solution, a method is provided which is carried out in the location server 130 for obtaining location data for the UE 1 connected through the access network 120. The method comprises:

negotiating positioning configuration data with the user equipment, comprising
a determined trustworthiness requirement associated with the positioning; and
scheduling of a reference signal for positioning in said access network using a positioning technique dependent on Radio Access Technology, RAT;

obtaining positioning data, generated by using at least one of: said RAT dependent positioning technique, and a RAT independent positioning technique satisfying said trustworthiness requirement.

According to the solution proposed herein, positioning is provided by evaluating all available positioning techniques for the UE 1. The UE 1 may have different technologies deployed in its chipsets of acquiring positioning data for determination of its geographical coordinates, both RAT dependent and RAT independent. The different technologies may have different errors and different accuracies. The solution enables use of all available, or for the time being relevant, positioning techniques in a controlled way to resource and power-efficiently support the configured trustworthiness requirements. The trustworthiness information and positioning information from any positioning technique can be used on the UE-side or communicated by LPP protocol to the location server 130 to assist fulfilling a predetermined positioning requirement. In various examples, the positioning requirements may be defined by a predetermined positioning service level. Non-limiting examples of performance requirements of Horizontal and Vertical positioning service levels may include those outlined in Table 1 below, as outlined in 3GPP document TS 22.261 section 7.3.2.2

TABLE 1

| | | Accuracy (95% | | | | Coverage, environment of use and UE velocity | | |
|---|---|---|---|---|---|---|---|---|
| | Absolute(A) | confidence | | | | | 5G enhanced positioning | |
| Positioning | or | level) | | Positioning | Positioning | | service area | |
| service | Relative(R) | Horizontal | Vertical | service | service | 5G positioning | Outdoor and | |
| level | positioning | Accuracy | Accuracy | availability | latency | service area | tunnels | Indoor |
| 1 | A | 10 m | 3 m | 95% | 1 s | Indoor-up to 30 | NA | Indoor-up |
| | | | | | | km/h | | to 30 km/h |
| | | | | | | Outdoor | | |
| | | | | | | (rural and urban) | | |
| | | | | | | up to 250 km/h | | |
| 2 | A | 3 m | 3 m | 99% | 1 s | Outdoor | Outdoor | Indoor-up |
| | | | | | | (rural and urban) | (dense urban) up | to 30 km/h |
| | | | | | | up to 500 km/h for | to 60 km/h | |
| | | | | | | trains and up to | Along roads up to | |
| | | | | | | 250 km/h for other | 250 km/h and | |
| | | | | | | vehicles | along railways up | |
| | | | | | | | to 500 km/h | |
| 3 | A | 1 m | 2 m | 99% | 1 s | Outdoor | Outdoor | Indoor-up |
| | | | | | | (rural and urban) | (dense urban) up | to 30 km/h |
| | | | | | | up to 500 km/h for | to 60 km/h | |
| | | | | | | trains and up to | Along roads up to | |
| | | | | | | 250 km/h for other | 250 km/h and | |
| | | | | | | vehicles | along railways up | |
| | | | | | | | to 500 km/h | |
| 4 | A | 1 m | 2 m | 99.9% | 15 ms | NA | NA | Indoor-up |
| | | | | | | | | to 30 km/h |
| 5 | A | 0.3 m | 2 m | 99% | 1 s | Outdoor | Outdoor | Indoor-up |
| | | | | | | (rural) up to 250 | (dense urban) up | to 30 km/h |
| | | | | | | km/h | to 60 km/h | |
| | | | | | | | Along roads and | |
| | | | | | | | along railways up | |
| | | | | | | | to 250 km/h | |
| 6 | A | 0.3 m | 2 m | 99.9% | 10 ms | NA | Outdoor | Indoor-up |
| | | | | | | | (dense urban) up | to 30 km/h |
| | | | | | | | to 60 km/h | |

| | | | | | | |
|---|---|---|---|---|---|---|
| 7 | R | 0.2 m | 0.2 m | 99% | 1 s | Indoor and outdoor (rural, urban, dense urban) up to |
| | | | | | | 30 km/h |
| | | | | | | Relative positioning is between two UEs within 10 m |
| | | | | | | of each other or between one UE and 5G positioning |
| | | | | | | nodes within 10 m of each other |

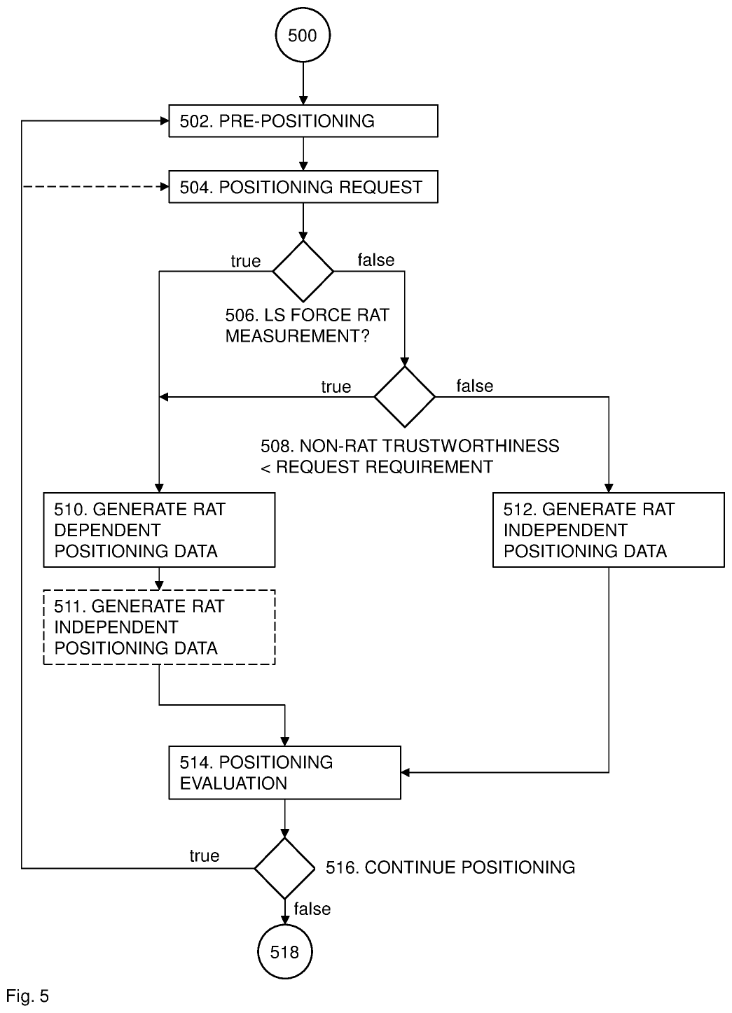

FIG. 5 schematically illustrates a flowchart of various process steps carried out in a method operated according to various examples of the proposed solution, starting at 500.

In a step 502, trustworthiness configuration and positioning to estimate the position of UE1 are set-up by negotiation of positioning configuration data between the location server 130 and the UE 1. This may involve the location server 130 collecting or determining information from any other type of previously performed positioning. This step can also be a complete first-time initialization of the positioning. It can be seen as a start-state of the method and a preparation step for information used in steps 506 and 508 described below. This pre-positioning step 502 comprises determining a trustworthiness requirement associated with the positioning. This may in various examples comprise the location server 130 setting up thresholds for the UE 1 to use in the evaluation of step 508. In some examples, this pre-positioning step 502 further comprises determining a reference signal configuration for positioning associated with the trustworthiness requirement in said access network using a positioning technique dependent on Radio Access Technology, RAT. The reference signal may e.g. be a PRS to be transmitted from the access network 120. In another example, the reference signal may be an uplink signal to be transmitted by the UE 1, for receipt in the access network 120. Scheduling of reference signals are carried out by the location server 130 and/or the base stations of the access network 120, and the scheduling is conveyed to the UE 1 as positioning configuration data. It should be noted that the mentioned scheduling of reference signals for positioning purposes may as such be repeatedly made closer in time to, or in association with, the transmission of such reference signals for positioning purposes and/or transmission of a positioning request, as outlined below.

Step 504 comprises obtainment of a positioning request. In some examples, the positioning request may be provided by an application running in an application client of the UE 1. In other examples, the positioning request may be triggered or transmitted from the location server 130. The location request may in various examples be seen as a request for the UE 1 to act to generate positioning data, for use in the location server 130 to determine a position estimation of the UE 1.

In various examples of the proposed solution, the location server 130 has the option to force positioning measurements by the UE 1 based on the reference signal, such as the PRS. By this arrangement, a mechanism is provided for making sure that the wireless network, by means of the location server 130, is in control of the UE 1 operation and its positioning activities, such as measurements and estimations made on the reference signal. This way the location server 130 can always get the measurements it wants. In other examples, or in other cases when forced measurement is not activated, the location server 130 may leave some or all of the control to the UE 1, which will be outlined below with reference to step 512.

In step 506, if measurements of the reference signal by the UE 1 are forced, the UE 1 will proceed to step 510 to generate positioning data using the RAT dependent technique. Forced use may be determined by the UE 1 based on an indicator received from the location server 130. The forced use indicator may in some examples be received in the positioning request 504, or in the pre-position step 502. In some examples, the forced use indicator be associated with one or more applications, as determined in the pre-position setup 502, and may thus be implicitly obtained with the positioning request by mapping to an application triggering the positioning request 504.

Step 510 may involve using scheduling information obtained from the location server 130, or the access network 120, to receive and measure characteristics of a downlink reference signal. The UE 1 will, in such an example, further transmit a measurement report identifying the generated positioning data to the location server 130. In an alternative example, step 510 may involve the UE transmitting a reference signal according to scheduling information obtained from the location server 130, or the access network 120, for reception of the reference signal in the access network 120 and determination of measurement characteristics of the uplink reference signal. Then, the access network 120 provides thus-obtained positioning data to the location server 130. In such an embodiment, the UE 1 is thus not configured to measure downlink reference signals, such as PRS. Instead, base stations 121, 122 of the access network 120 are configured to perform measurements on uplink reference signals transmitted from the UE 1, such as a Sounding Reference Signal (SRS), for positioning of the UE 1.

If, at step 506, there is no forced use of reference signals, the process may continue to step 508. The UE 1 may have full information of any positioning technique it has built-in to evaluate the trustworthiness that was negotiated and setup with the location server 130. In the evaluation of step 508, if the UE 1 determines that it has no positioning data, i.e. no RAT independent technique available to obtain positioning data, that fulfills the trustworthiness requirement, the UE 1 will proceed to step 510 and carry out the described acts for that step, such as read and measure PRS signals scheduled by location server 130. If, on the other hand, the UE 1 determines that any other available RAT independent positioning technique fulfills the requirement of the trustworthiness configuration, there is no need for measuring the PRS, and the process will instead continue to step 512.

In step 512, the UE will generate positioning data using an available RAT independent technique which satisfies the trustworthiness requirement. As previously outlined, this may e.g. involve obtaining GNSS signals or signals from other transmitters such as BT or wi-fi, or sensors, for generation of positioning data. This step may in some examples also involve determining the position estimation of the UE 1, by means of the logic 210 of the UE 1. In such an example, the step 512 may further comprise transmitting the position estimation to the location server 130. In another example, the generated positioning data may be transmitted as raw data or partly processed by the logic 210, to the location server 130 for determination of the position estimation.

Going back to the scenario where measurements of the reference signal by the UE 1 are forced and the UE 1 proceeds to step 510 to generate positioning data using the RAT dependent technique, the UE 1 may in some embodiments further generate 511 positioning data also using an available RAT independent technique which satisfies the trustworthiness requirement. This may involve any of the steps and techniques described with reference to step 512, including to use already obtained and stored positioning measurements. In such embodiments, forced UE measurements of the reference signal by the UE 1 does thus not preclude generation also of positioning data using an available RAT independent technique.

In step 514, a step of position estimation evaluation may be carried out. When the location server 130 receives a measurement report from UE 1, or from the access network 120 if the UE 1 has been scheduled to transmit an uplink reference signal, the location server 130 will be updated as to whether the UE 1 has used downlink reference signals, such as PRS. The location server 130 will utilize the obtained positioning data, to update its position estimate of the UE 1. In some examples, the location server is configured to update one or both of reference signal settings and resource allocation for reference signals, based on a collection of results from one or a plurality of UEs. This way, the location server 130 may be configured to tune the scheduling or the characteristics of reference signal transmission from the access network 120, and thereby minimize the air traffic.

Based on the need, a decision may be taken at step 516 to continue positioning by refreshing the pre-positioning setup 502 or triggering a new positioning request 504. Otherwise, the process will end at 518.

By means of the proposed solution, the UE 1 is configured to evaluate the trustworthiness requirements to proceed with generation of positioning data using at least one of a RAT dependent positioning technique and a RAT independent positioning technique satisfying the trustworthiness requirements. Where such a RAT independent positioning technique is available for use in the UE 1, or position data generated with such a RAT independent technique is already generated in the UE 1, the UE 1 can avoid making measurements on reference signals. This way, power-consuming and latency-generating processes in the UE 1 associated with receiving reference signals and making measurements may be avoided.

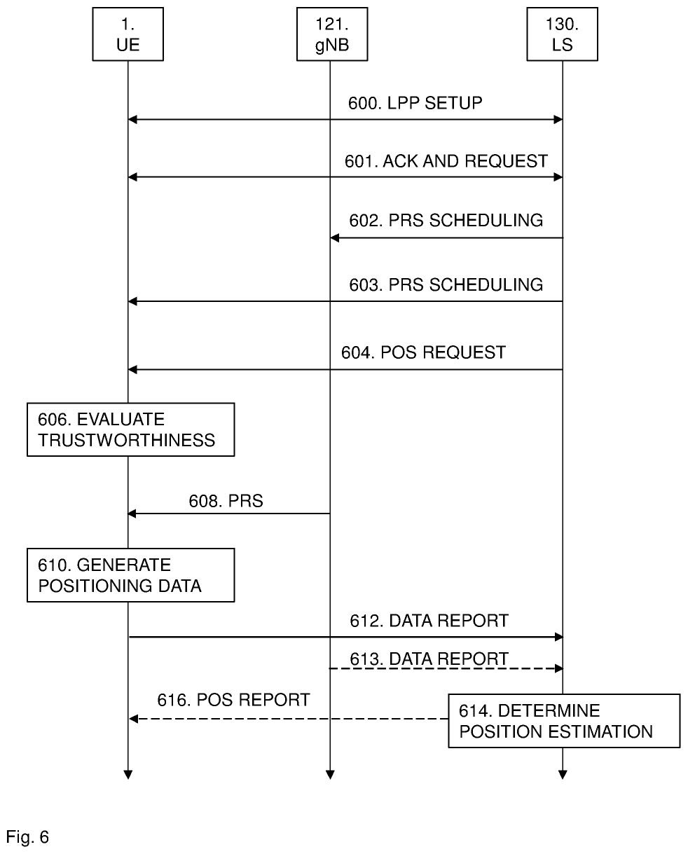

FIG. 6 illustrates the method according to the proposed solution in a different way, by means of a message sequence chart showing more clearly the signaling added to support the method. In some examples, this can be seen as one iteration of the loop in FIG. 5.

Negotiation of positioning configuration data between the UE 1 and the location server 130 may include positioning and trustworthiness settings 600 being conveyed from the location server 130 to the UE 1, e.g. over LPP. This may further comprise the UE 1 acknowledging settings, and optionally indicating a request to change trustworthiness settings. In some examples, this includes the UE 1 transmitting an indication of a trustworthiness parameter value associated with one or more RAT independent technique, available to the UE 1. This may be used in the location server 130 to redefine the trustworthiness settings for the positioning. The negotiation may be statically configured at start up or at any time before a positioning request 604. The setting can be further reconfigured at any time, and this can be initiated by any of UE 1 or the location server 130. By means of this negotiation, trustworthiness parameters may be conveyed by the UE 1, for configuration of the trustworthiness requirements by the location server 130. This way, the trustworthiness requirements may be adapted to assist the UE in taking a decision on whether PRS should be measured.

Scheduling of a reference signal, such as a PRS, for positioning in the access network 120, may be shared 602 to the access network 120 and shared 603 to the UE 1 by the location server 130. The scheduling of legacy PRS transmission is not shown here. In this case, the access network 120 provides PRS configuration/scheduling to location server 130, e.g. using NRPPa protocol. Then, the location server 130 provides the information to UE 130.

A positioning request 604 may be triggered by the location server 130 and shared with the UE 1. As noted, the positioning request may be a specific indication provided by the location server 130 or determined by the UE 1 by way of association with an application requesting a position estimation. Further settings, such as updated trustworthiness configuration or service level parameters may also be conveyed to the UE 1 with the positioning request 604. In some examples, as outlined, information may further be conveyed, in or in association with the positioning request 604, indicating whether reference signal measurement shall be forced even if trustworthiness requirements are fulfilled by other RAT independent positioning techniques in the UE 1.

Unless reference signal measurement is forced, the UE 1 will further evaluate 606 trustworthiness thresholds and take a decision on measuring reference signals or not. This involves taking a decision on using a RAT dependent technique or a RAT independent technique for positioning. In some examples, the evaluation 606 is carried out just before the scheduled reference signal, and thus before reference signal measurement, where applicable. The evaluation 606 may determine that reference signal measurement is forced, or that reference signal measurement signal measurement is nevertheless required based on the trustworthiness requirement, due to non-availability of RAT independent positioning techniques or due to available RAT independent positioning techniques currently not meeting the trustworthiness requirement. In some examples, if a RAT independent positioning techniques meeting the trustworthiness requirement is currently available, the UE 1 is configured to proceed with generation of positioning data based on that RAT independent positioning technique.

Reference signals 608 are transmitted by the access network 120, according to the determined scheduling. In some examples, the reference signals are periodically broadcasted for use by any UE.

The UE 1 subsequently generates 610 positioning data. Where a RAT independent positioning technique is used, or positioning data previously obtained using such a RAT independent positioning technique is already available, no attention needs to be made to the reference signal 608. Where the evaluation 606 configures the UE 1 to reference signal measurement, the generation of positioning data may include measuring one or more characteristics of the scheduled positioning signals 608. The generation of positioning data may further comprise consolidating a report to the location server.

The UE 1 may further transmit a positioning measurement data report 612. As outlined, the data report may comprise raw or partly processed positioning data, or a position estimation determined based on a RAT independent technique. Optionally, both a position estimation based on a RAT independent technique and measurement data based on a forced RAT dependent technique may be conveyed in the data report 612.

A position estimation 614 may be determined by the location server 130. This may involve carrying out positioning estimation by the location server based on a data report 612 of measurements of reference signals received in the UE 1, or an update with a position estimation based on trustworthiness checked positioning data from a RAT independent technique as obtained from the UE 1. Alternatively, or additionally, this may involve carrying out positioning estimation by the location server 130 based on a data report 613 of measurements made in the access network 120 of uplink reference signals received from the UE 1.

The determined position estimation may in some examples be conveyed 616 to the UE 1, e.g. where the position estimation is carried out in the location server 130 based on a RAT dependent technique.

Various aspects of the proposed solution have been outlined in the foregoing and are further set out in the claims. These aspects involve inter alia that the UE 1 is configured to make use of a RAT dependent technique based on reference signals conveyed between the access network 120 and the UE 1 only if a trustworthiness evaluation does not fulfill a configured trustworthiness configuration determined based on RAT independent techniques available to the UE 1. According to another aspect, the UE 1 is configured with the ability to choose a RAT independent technique for position estimation if it fulfills the negotiated configured trustworthiness configuration. According to another aspect, the access network 120 may be configured to refrain from providing scheduling information of reference signals for RAT dependent positioning to the UE 1 if the negotiated trustworthiness is based on a RAT independent technique as determined by the negotiation between the UE 1 and the location server 130. According to another aspect, the proposed method provides for the UE 1 to assist the location server 130 with configuration of the trustworthiness configuration based on RAT independent techniques.

The proposed solution may be provided by any combination of the subject matter as set out in the foregoing, and as set out in the following claims.

1. A method carried out in a user equipment for generating positioning data for a location server connected through an access network, the method comprising:
negotiating positioning configuration data with the location server, the positioning configuration data comprising
a determined trustworthiness requirement associated with the positioning; and
scheduling of a reference signal for positioning in said access network using a positioning technique dependent on Radio Access Technology (RAT);
obtaining a positioning request;
generating, in response to the positioning request, positioning data by using at least one of: said RAT dependent positioning technique, and a RAT independent positioning technique satisfying said trustworthiness requirement.

2. The method of claim 1, comprising:
using said RAT independent technique to generate the positioning data, responsive to the RAT independent positioning technique satisfying said trustworthiness requirement.

3. The method of claim 1, comprising:
using at least the RAT dependent technique to generate the positioning data, based on a forced use indicator received from the location server.

4. The method of claim 3, wherein said forced use indicator is received with the positioning request.

5. The method of claim 2, comprising:
refraining from using the RAT dependent technique.

6. The method of claim 1, wherein determining a trustworthiness requirement comprises:
transmitting, to the location server, an indication of a trustworthiness parameter value associated with said RAT independent technique, wherein the trustworthiness requirement is determined based on said indication.

7. The method of claim 1, wherein said scheduling of the reference signal is received from the location server or the access network.

8. The method of claim 1, wherein said reference signal for positioning is transmitted by the access network, and wherein generating positioning data using said RAT dependent technique comprises:
determining measurement data based on the received reference signal.

9. The method of claim 1, comprising:
transmitting a measurement report identifying the generated positioning data to the location server.

10. The method of claim 1, wherein generating positioning data comprises:
transmitting said reference signal to the access network, for position determination by the location server using said RAT dependent technique.

11. A method carried out in a location server for obtaining location data for a user equipment connected through an access network, the method comprising:
negotiating positioning configuration data with the user equipment, the positioning configuration data comprising
a determined trustworthiness requirement associated with the positioning; and
scheduling of a reference signal for positioning in said access network using a positioning technique dependent on Radio Access Technology (RAT);
obtaining positioning data, generated by using at least one of: said RAT dependent positioning technique, and a RAT independent positioning technique satisfying said trustworthiness requirement.

12. The method of claim 11, wherein, responsive to the RAT independent positioning technique satisfying said trustworthiness requirement, the positioning data is generated in the user equipment using said RAT independent technique.

13. The method of claim 11, comprising transmitting said scheduling of the reference signal to the user equipment.

14. The method of claim 11, comprising:
transmitting a positioning request to the user equipment, wherein the positioning data is obtained based on the positioning request.

15. The method of claim 11, comprising:
transmitting a forced use indicator to the user equipment;
wherein, responsive to the forced use indicator, the positioning data is generated using at least the RAT dependent technique.

16. The method of claim 14, wherein said forced use indicator is transmitted with the location request.

17. The method of claim 15, wherein no positioning data is generated using the RAT dependent technique.

18. The method of claim 11, wherein determining a trustworthiness requirement comprises:
receiving, from the user equipment, an indication of a trustworthiness parameter value associated with said RAT independent technique, wherein the trustworthiness requirement is determined based on said indication.

19. The method of claim 11, wherein said reference signal for positioning is transmitted by the access network, and wherein obtaining positioning data using said RAT dependent technique comprises:
receiving measurement data from the user equipment obtained based on the reference signal.

20. The method of claim 11, wherein obtaining positioning data comprises:
obtaining information of receipt in the access network of said reference signal from the user equipment; and
generating the positioning data based on said RAT dependent technique.

21. (canceled)
